(19) United States
(12) Patent Application Publication
(10) Pub. No.: US 2025/0111017 A1
(43) Pub. Date: Apr. 3, 2025

(54) INFORMATION PROCESSING METHOD, INFORMATION PROCESSING DEVICE, AND RECORDING MEDIUM

(71) Applicant: Panasonic Intellectual Property Corporation of America, Torrance, CA (US)

(72) Inventors: Takeru KOIE, Saitama (JP); Kakuya YAMAMOTO, Hyogo (JP)

(21) Appl. No.: 18/978,157

(22) Filed: Dec. 12, 2024

Related U.S. Application Data
(63) Continuation of application No. PCT/JP2023/009594, filed on Mar. 13, 2023.
(60) Provisional application No. 63/354,761, filed on Jun. 23, 2022.

(51) Int. Cl. G06F 21/16; H04L 9/08; H04L 9/32

(52) U.S. Cl. CPC G06F 21/16; H04L 9/0825; H04L 9/3247

(57) ABSTRACT

An information processing method includes: obtaining (a) content data which represents content and in which a digital watermark is embedded and (b) tag information associated with the content data; verifying whether there is a match between information of an owner of the content that is specified based on the digital watermark and information of the owner of the content that is obtained from the tag information; and when the verifying is successful, presenting the content.

### CROSS REFERENCE TO RELATED APPLICATIONS

This is a continuation application of PCT International Application No. PCT/JP2023/009594 filed on Mar. 13, 2023, designating the United States of America, which is based on and claims priority of U.S. Provisional Patent Application No. 63/354,761 filed on Jun. 23, 2022. The entire disclosures of the above-identified applications, including the specifications, drawings and claims are incorporated herein by reference in their entirety.

### FIELD

The present disclosure relates to information processing methods, information processing devices, and recording media.

### BACKGROUND

One usage of distributed ledger systems such as a blockchain is the circulation of non-fungible tokens (NFTs). NFTs contribute to the circulation of digital data with the uniqueness thereof guaranteed.

Non Patent Literature (NPL) 1 discloses an NFT implementation method defined on Ethereum which is one of blockchain platforms.

### CITATION LIST

### Non Patent Literature

NPL 1: ERC-721 Non-Fungible Token Standard, [Jan. 1, 2023], Internet website <URL: https://ethereum.org/ja/developers/docs/standards/tokens/erc-72 1/>

### SUMMARY

### Technical Problem

However, there are cases where a malicious third party can circulate an NFT in such a manner that the uniqueness of digital data is not guaranteed, which is problematic.

Thus, the present disclosure provides an information processing method that contributes to the circulation of content data with the uniqueness thereof guaranteed.

### Solution to Problem

An information processing method according to one aspect of the present disclosure includes: obtaining (a) content data which represents content and in which a digital watermark is embedded and (b) tag information associated with the content data; verifying whether there is a match between information of an owner of the content that is specified based on the digital watermark and information of the owner of the content that is obtained from the tag information; and when the verifying is successful, presenting the content.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, and recording media.

### Advantageous Effects

The present disclosure contributes to the circulation of content data with the uniqueness thereof guaranteed.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the overall configuration of a verification system according to an embodiment.

FIG. 2 is a configuration diagram of an NFT browsing terminal according to an embodiment.

FIG. 3 is a configuration diagram of an NFT registrant and owner terminal according to an embodiment.

FIG. 4 is a configuration diagram of a ledger server according to an embodiment.

FIG. 5 is a configuration diagram of a digital watermark server according to an embodiment.

FIG. 6 is a configuration diagram of a service server according to an embodiment.

FIG. 7 is a sequence chart illustrating processes performed in a verification system according to an embodiment.

FIG. 8 is a sequence chart illustrating the first example of an NFT registration process according to an embodiment.

FIG. 9 is a sequence chart illustrating the second example of an NFT registration process according to an embodiment.

FIG. 10 is a sequence chart illustrating the first half part of one example of an NFT exhibition process according to an embodiment.

FIG. 11 is a sequence chart illustrating the second half part of one example of an NFT exhibition process according to an embodiment.

FIG. 12 is an explanatory diagram illustrating one example of the structure of exhibition data according to an embodiment.

FIG. 13 is a sequence chart illustrating one example of an NFT presentation process according to an embodiment.

FIG. 14 is an explanatory diagram illustrating the data structure of a blockchain.

FIG. 15 is an explanatory diagram illustrating the data structure of transaction data.

### DESCRIPTION OF EMBODIMENT

### Underlying Knowledge Forming Basis of the Present Disclosure

The inventors found that the following problems occur in the technique involving NFTs described in the “Background” section.

As mentioned above, NFTs contribute to the circulation of digital data with the uniqueness thereof guaranteed. However, there are cases where a malicious third party can circulate an NFT in such a manner that the uniqueness of digital data is not guaranteed, which is problematic.

For example, there are cases where a malicious third party can copy digital data the uniqueness of which is guaranteed by an NFT and register the digital data with a new NFT. In this case, two or more NFTs are registered for the same digital data, resulting in a situation where the digital data with the two or more NFTs is circulated. This causes the problem that viewers cannot determine which NFT among the two or more registered NFTs is authentic (that is, original) digital data.

Furthermore, there is the problem that a malicious third party can pretend to be the owner of an NFT owned by another person and improperly exhibit the NFT in an exhibition space.

Thus, the present disclosure provides an information processing method that contributes to the circulation of digital data with the uniqueness thereof guaranteed.

Hereinafter, the disclosure of the present specification will be described as an example, and advantageous effects, etc., obtained from the disclosure will be explained.

(1) An information processing method includes: obtaining (a) content data which represents content and in which a digital watermark is embedded and (b) tag information associated with the content data; verifying whether there is a match between information of an owner of the content that is specified based on the digital watermark and information of the owner of the content that is obtained from the tag information; and when the verifying is successful, presenting the content.

According to this aspect, using the tag information associated with the content data to be presented, the content data can be verified as content data provided by a legitimate owner; thereafter, content presentation can be controlled. Thus, when the obtained content data is an unauthorized copy of authentic content data, presentation of said content is eliminated, allowing for reduced circulation of unauthorized copies of authentic content data. In this manner, the aforementioned information processing method contributes to the circulation of content data with the uniqueness thereof guaranteed.

(2) In the information processing method described in (1), the digital watermark includes content identification (ID) that is an identifier of the content, the tag information includes a digital signature of the owner of the content, and when there is a match between information of the owner of the content that is specified using the content ID read from the digital watermark and information of the owner of the content that is obtained from the digital signature, the content is presented.

According to this aspect, using the content ID of the content and the digital signature of the owner of the content, it can be more easily verified that a legitimate owner has provided the content data; thereafter, content presentation can be controlled. Thus, the aforementioned information processing method contributes to the circulation of content data with the uniqueness thereof guaranteed.

(3) The information processing method described in (2) further includes: obtaining a public key of the owner of the content that is specified using the content ID read from the digital watermark; verifying, using the public key obtained, the digital signature included in the tag information; and when the verifying of the digital signature is successful, presenting the content.

According to this aspect, using the digital signature included in the tag information associated with the content data to be presented, the content data can be verified as content data provided by a legitimate owner; thereafter, content presentation can be controlled. Thus, when the obtained content data is an unauthorized copy of authentic content data, presentation of said content is eliminated, allowing for reduced circulation of unauthorized copies of authentic content data. In this manner, the aforementioned information processing method contributes to the circulation of content data with the uniqueness thereof guaranteed.

Furthermore, according to this aspect, in the circulation of an NFT, the authenticity of the NFT can be verified using a terminal used by a user and a distributed ledger, meaning that regardless of what platform the NFT is presented on, the aforementioned information processing method contributes to the circulation of authentic content data with the uniqueness thereof guaranteed.

(4) In the information processing method described in (3), when the verifying of the digital signature is unsuccessful, the presenting of the content is prohibited.

According to this aspect, when the verification of the content data as having been provided by a legitimate owner is unsuccessful, the presentation of the content can be prohibited so that content different from authentic content data is not presented. Thus, the circulation of unauthorized copies of authentic content data can be further reduced. In this manner, the aforementioned information processing method further contributes to the circulation of content data with the uniqueness thereof guaranteed.

(5) In the information processing method described in (3) or (4), the verifying further includes: when it is determined that there is no match between the content ID read from the digital watermark and the content ID included in the tag information, causing the verifying to be unsuccessful.

According to this aspect, the content data can be verified using also determination on whether there is a match between the content ID read from the digital watermark and the content ID included in the tag information. Thus, the circulation of unauthorized copies of authentic content data can be further reduced. In this manner, the aforementioned information processing method further contributes to the circulation of content data with the uniqueness thereof guaranteed.

(6) In the information processing method described in any one of (3) to (5), the content has been registered as registered content by a plurality of servers included in a distributed ledger network, in a distributed ledger held by the plurality of servers, registrant information indicating a registrant who has registered the content as the registered content is stored, the digital watermark further includes registrant information indicating the registrant who has registered the content, and the verifying further includes: when it is determined that there is no match between the registrant information indicating the registrant and having been read from the digital watermark and the registrant information stored in the distributed ledger, causing the verifying to be unsuccessful.

According to this aspect, the content data can be verified using also determination on whether there is a match between the registrant read from the digital watermark and the registrant stored and managed in the distributed ledger. Thus, the circulation of unauthorized copies of authentic content data can be further reduced. In this manner, the aforementioned information processing method further contributes to the circulation of content data with the uniqueness thereof guaranteed.

(7) In the information processing method described in any one of (3) to (6), the content has been registered as registered content by a plurality of servers included in a distributed ledger network, in a distributed ledger held by the plurality of servers, the content ID, a record of transfer of the content, and a public key to an owner account holding the content are stored in association each other, and the obtaining of the public key includes: obtaining the public key to the owner account holding the content that is associated with the content ID.

According to this aspect, the digital signature included in the tag information is verified using the public key of the owner account holding the content that is stored and managed in the distributed ledger, and therefore it is possible to more properly verify whether the content data has been provided by a legitimate owner; as a result, the circulation of unauthorized copies of authentic content data can be reduced. Thus, the aforementioned information processing method further contributes to the circulation of content data with the uniqueness thereof guaranteed.

(8) In the information processing method described in any one of (3) to (7), in the obtaining of the content data and the tag information, one electronic file including the content data and the tag information is obtained.

According to this aspect, by obtaining one electronic file, it is possible to obtain, at a time, a collection of the content data and the tag information associated with said content data, and thus the content data can be more easily verified using the content data and the tag information that have been obtained at a time. If the content data and the tag information associated with said content data are obtained as separate electronic files, association information indicating that the content data and the tag information obtained are associated with each other may further be required. When one electronic file is obtained as described above, the association information is not required, and the content data and the tag information obtained can be easily managed in association with each other. Thus, the aforementioned information processing method more easily contributes to the circulation of content data with the uniqueness thereof guaranteed.

(9) In the information processing method described in any one of (1) to (8), the content data is a non-fungible token (NFT).

According to this aspect, the circulation of unauthorized copies of content data that is an NFT can be reduced. Thus, the aforementioned information processing method contributes to the circulation of content data that is an NFT with the uniqueness thereof guaranteed.

(10) An information processing device includes: a data obtainer that obtains (a) content data which represents content and in which a digital watermark is embedded and (b) tag information associated with the content data; a verifier that verifies whether there is a match between information of an owner of the content that is specified based on the digital watermark and information of the owner of the content that is obtained from the tag information; and a presentation unit that when the verifying is successful, presents the content.

According to this aspect, the information processing device produces substantially the same advantageous effects as those produced in the aforementioned information processing method.

(11) A non-transitory computer-readable recording medium having recorded thereon a program for causing a computer to perform the information processing method described in (1).

According to this aspect, the recording medium produces substantially the same advantageous effects as those produced in the aforementioned information processing method.

Note that these general and specific aspects may be implemented using a system, a device, an integrated circuit, a computer program, or a computer-readable recording medium such as CD-ROM, or any combination of systems, devices, integrated circuits, computer programs, and recording media.

Hereinafter, an embodiment will be specifically described with reference to the drawings.

Note that each embodiment described below shows a general or specific example. The numerical values, shapes, materials, structural elements, the arrangement and connection of the structural elements, steps, the processing order of the steps, etc., shown in the following embodiment are mere examples, and are not intended to limit the present disclosure. Therefore, among the structural elements in the following embodiment, structural elements not recited in any one of the independent claims which indicate the broadest concepts will be described as optional structural elements.

### Embodiment

The present embodiment describes an information processing method, an information processing device, etc., that contribute to the circulation of content data with the uniqueness thereof guaranteed.

### 1. System Configuration

### 1.1 Overall Configuration of Verification System 10

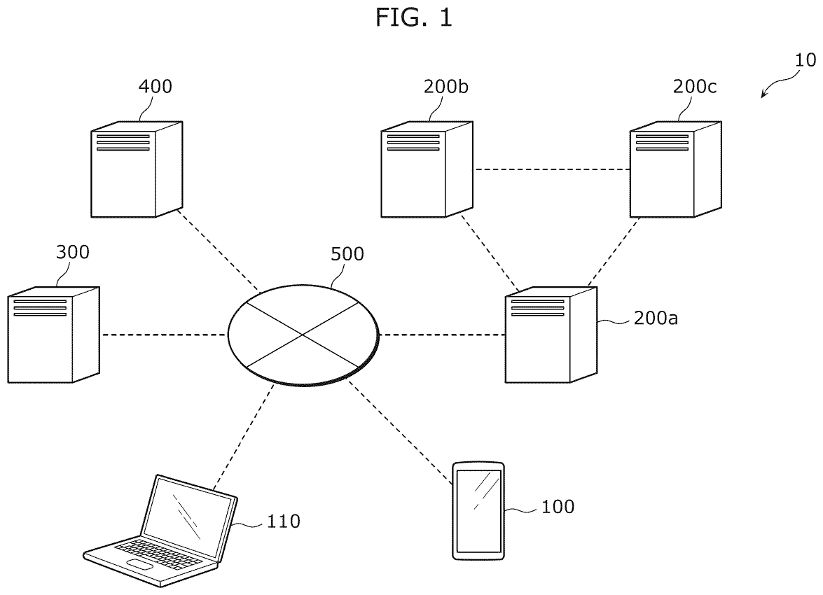

FIG. 1 is a schematic diagram illustrating the overall configuration of verification system 10 according to the present embodiment. Verification system 10 verifies an NFT using a digital watermark, thereby contributing to the circulation of content data with the uniqueness thereof guaranteed.

The NFT can be content data representing certain content. The content data is image data, for example, and this case will be described as an example. When the NFT is image data, presenting the NFT is equivalent to displaying the image data on a display screen. Note that the NFT may be sound data or data including arbitrary information. When the NFT is sound data, presenting the NFT is equivalent to outputting the sound data in the form of sound from a speaker.

As illustrated in FIG. 1, verification system 10 includes terminals 100, 110, ledger servers 200a, 200b, 200c (also referred to as ledger server 200a, etc.), digital watermark server 300, and service server 400. Devices included in verification system 10 are connected to each other so as to allow communication therebetween via communication network 500.

Terminal 100 is a terminal used by a user to browse image data that is an NFT. Terminal 100 displays image data that is an NFT exhibited by service server 400, thereby allowing a user to browse the image data that is an NFT.

Terminal 110 is a terminal that holds image data to be registered as an NFT. Terminal 110 registers image data on a blockchain as an NFT and provides the image data to service server 400 in order to exhibit the image data. Note that terminal 110 is described herein as one terminal that holds an NFT and registers the NFT, but the functions of terminal 110 may be divided so that two terminals, namely, an NFT registrant terminal and an NFT owner terminal, include the divided functions. The NFT registrant terminal is a terminal that registers image data to be registered as an NFT on a blockchain as an NFT. The NFT owner terminal is a terminal that holds image data to be circulated as an NFT using a blockchain and provides the image data to service server 400 in order to exhibit the image data.

Ledger server 200a is a server that guarantees the authenticity of the image data held by terminal 100 or 110 and manages account information of terminal 100 or 110 by storing the account information in a distributed ledger. The distributed ledger is a blockchain, for example, and this case will be described as an example; however, distributed ledgers of other types (for example, IOTA or hashgraph) can also be used. Each of ledger servers 200b, 200c, which is a server that includes substantially the same functions as ledger server 200a, operates independently of ledger server 200a.

Digital watermark server 300 is a server that includes the function of embedding a digital watermark in image data and the function of reading a digital watermark embedded in image data. Digital watermark server 300 does not necessarily need to exist as a standalone server. The function of embedding a digital watermark in image data may be included in terminal 110, ledger server 200a, or the like. The function of reading a digital watermark embedded in image data may be included in terminal 100 or service server 400. In this case, verification system 10 does not need to include digital watermark server 300.

Service server 400 is a server that is managed by a service company. Service server 400 manages a user or a service in providing the service. Service server 400 exhibits the image data held by terminal 110, for example, and this case will be described as an example.

### 1.2 Configuration of Terminal 100

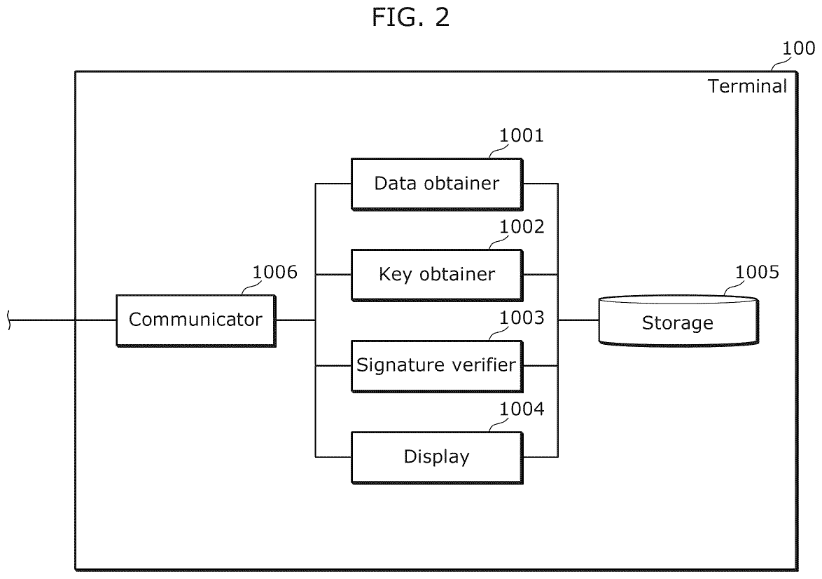

FIG. 2 is a configuration diagram of terminal 100 that displays an NFT.

As illustrated in FIG. 2, terminal 100 includes data obtainer 1001, key obtainer 1002, signature verifier 1003, display 1004, storage 1005, and communicator 1006. Terminal 100 is an information processing device including a user interface (for example, a display or a speaker and an input unit) such as a smartphone or a personal computer. Terminal 100 may be a head-mounted display.

Data obtainer 1001, key obtainer 1002, and signature verifier 1003 included in terminal 100 may be implemented by at least a processor (for example, a central processing unit (CPU)) included in terminal 100 executing a predetermined program using memory.

Data obtainer 1001 obtains exhibition data from service server 400. The exhibition data includes: image data that is a target to be exhibited; and an NFT tag associated with the image data, for example.

Key obtainer 1002 obtains a public key to a designated account from a blockchain held by ledger server 200a, etc. For example, key obtainer 1002 obtains a public key to an account that holds an NFT (also referred to as an owner account or an owner).

Signature verifier 1003 verifies a digital signature (also referred to simply as a signature) using the public key obtained by key obtainer 1002. The signature to be verified is a signature added, using the private key to terminal 110, to an NFT tag issued by service server 400, for example. The verification of the signature included in the NFT tag by signature verifier 1003 is also referred to as NFT tag verification. Note that signature verifier 1003 may be replaced by a verifier that verifies whether there is a match between information of an owner identified on the basis of the digital watermark and information of a content owner obtained from the NFT tag.

Display 1004 displays the image data on the display screen included in terminal 100. Display 1004 may be a display screen. Display 1004 displays the image data obtained from service server 400. At the time of displaying the image data, display 1004 transmits image data with a digital watermark embedded therein to digital watermark server 300, and obtains information embedded in the image as the digital watermark. The obtained information can be used to obtain the public key to the NFT owner account.

Note that verification system 10 may include a speaker that outputs sound instead of display 1004 or in addition to display 1004. When the NFT is sound data, terminal 100 outputs the sound data that is an NFT from the speaker. Verification system 10 may include a presentation unit that includes at least one of a display and a speaker instead of display 1004.

Storage 1005 is a storage device in which the public key obtained by key obtainer 1002 and the image data obtained by data obtainer 1001 are stored.

Communicator 1006 communicates with ledger server 200a, etc., digital watermark server 300, or service server 400. The communication may be performed using transport layer security (TLS). A cryptographic key for this TLS communication may be held in communicator 1006.

### 1.3 Configuration of Terminal 110

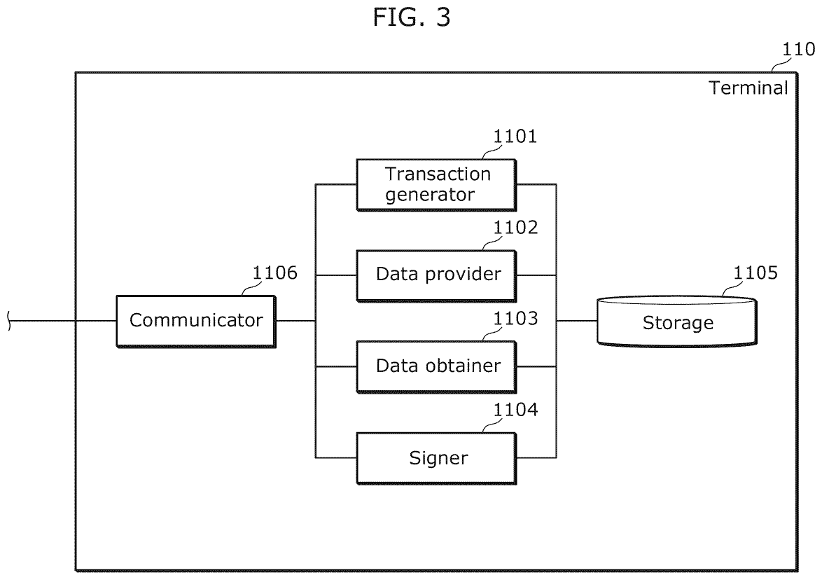

FIG. 3 is a configuration diagram of NFT registrant and owner terminal 110.

As illustrated in FIG. 3, terminal 110 includes transaction generator 1101, data provider 1102, data obtainer 1103, signer 1104, storage 1105, and communicator 1106. Terminal 110 is an information processing device including a user interface (for example, a display or a speaker and an input unit) such as a smartphone or a personal computer. Transaction generator 1101, data provider 1102, data obtainer 1103, and signer 1104 included in terminal 110 may be implemented by at least a processor (for example, a CPU) included in terminal 110 executing a predetermined program using memory.

Transaction generator 1101 generates transaction data related to NFT registration or transfer. Transaction generator 1101 stores the generated transaction data into storage 1105. Furthermore, transaction generator 1101 transmits the generated transaction data to ledger server 200a, etc., via communicator 1106. The transaction data generated by transaction generator 1101 includes registration request transaction data, ID request transaction data, or transfer transaction data (which will be described later).

Data provider 1102 provides the image data stored in storage 1105 to digital watermark server 300, service server 400, or the like via communicator 1106.

Data obtainer 1103 obtains image data with a digital watermark embedded therein via communicator 1106, and stores the obtained image data into storage 1105. Furthermore, data obtainer 1103 obtains, via communicator 1106, an NFT tag with no signature added thereto that is provided from service server 400, and stores the NFT tag into storage 1105.

Signer 1104 adds a signature to information stored in storage 1105. Information to which a signature is to be added is an NFT tag with no signature added thereto that is provided from service server 400.

Storage 1105 is a storage device in which the transaction data generated by transaction generator 1101, the image data obtained by data obtainer 1103, and the like are stored.

Communicator 1106 communicates with ledger server 200a, etc., digital watermark server 300, or service server 400. The communication may be performed using TLS. A cryptographic key for this TLS communication may be held in communicator 1106.

### 1.4 Configuration of Ledger Server 200a

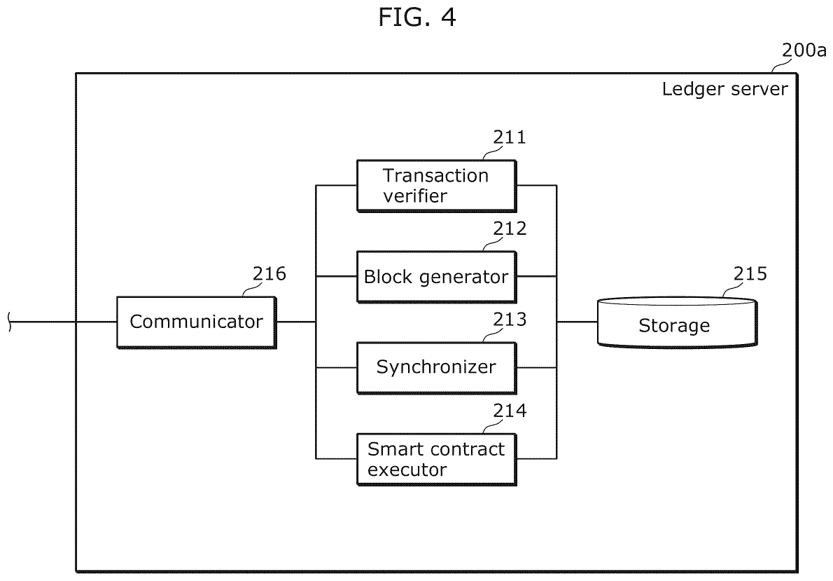

FIG. 4 is a configuration diagram of ledger server 200a according to the present embodiment. Ledger servers 200b, 200c have substantially the same configurations.

As illustrated in FIG. 4, ledger server 200a includes transaction verifier 211, block generator 212, synchronizer 213, smart contract executor 214, storage 215, and communicator 216. Ledger server 200a is a server that is a computer connected to communication network 500, but may be an information processing device such as a smartphone or a personal computer.

Transaction verifier 211, block generator 212, synchronizer 213, and smart contract executor 214 included in ledger server 200a may be implemented by a processor (for example, a CPU) included in ledger server 200a executing a predetermined program using memory. When the smart contract is executed, the predetermined program is automatically executed without the intervention of other persons or other systems. Thus, the smart contract allows a series of processes to be performed more securely.

Transaction verifier 211 verifies the received transaction data. Specifically, when transaction verifier 211 receives the transaction data transmitted by terminal 110, transaction verifier 211 verifies the authenticity of said transaction data using the signature included in the received transaction data. When transaction verifier 211 determines, as a result of the verification, that the received transaction data is authentic transaction data, transaction verifier 211 stores the transaction data into storage 215. When transaction verifier 211 determines that the received transaction data is authentic transaction data, transaction verifier 211 reports the result to synchronizer 213, and thus said transaction data is transmitted to other ledger servers 200b, 200c and synchronized.

The transaction data to be verified by transaction verifier 211 includes the registration request transaction data or the ID request transaction data transmitted by terminal 110. Furthermore, the transaction data to be verified by transaction verifier 211 includes the transfer transaction data indicating the transfer of an NFT. The transfer transaction data includes at least the NFT-ID of said NFT, a transfer source account (that is, an account that has held the image data before the transfer) and a transfer destination account (that is, an account that holds the image data after the transfer) for said NFT, and the public key to the transfer destination account. It can be said that the transfer transaction data indicates records of the transfer of the NFT.

Block generator 212 executes a consensus algorithm on the transaction data together with other ledger servers 200b, 200c. As the consensus algorithm, a consensus algorithm called practical byzantine fault tolerance (PBFT) may be used, or a traditionally proposed consensus algorithm such as proof of work (PoW) or proof of stake (PoS) may be used. Note that when Hyperledger Fabric is used as one example of the distributed ledger technology, it is not necessary to execute a consensus algorithm. When an agreement is made on one or more transaction data according to the consensus algorithm, block generator 212 generates a block and records the generated block on storage 215.

Synchronizer 213 synchronizes the block and the transaction data stored in the blockchain with ledger server 200a, etc. The block or the transaction data is synchronized in a peer-to-peer network, and the synchronized block or transaction data is stored into storage 215.

Specifically, when transaction data is received and the authenticity of the transaction data received is successfully verified, synchronizer 213 transfers the transaction data to ledger servers 200b, 200c, and records the transaction data on storage 215. Thus, it is possible to reduce the processor workload or reduce unnecessary memory consumption. Furthermore, synchronizer 213 receives transaction data from another ledger server 200b or 200c and stores the received transaction data into storage 215.

Smart contract executor 214 executes a smart contract by using a contract code recorded on storage 215. Specifically, when smart contract executor 214 receives registration request transaction data, smart contract executor 214 executes a smart contract for NFT registration. As a result of the execution of the smart contract for NFT registration, image data is registered as an NFT, and NFT-ID is issued and added to the image data that is an NFT.

Storage 215 is a storage device in which a blockchain is stored. Specifically, the block and the transaction data included in the blockchain are stored in storage 215. The block and the transaction data stored in storage 215 include, for example, the transaction data received from terminal 110, etc., and the block and the transaction data generated by ledger server 200a.

Communicator 216 communicates with terminal 100 or 110, service server 400, or another ledger server 200b or 200c. The communication may be performed using TLS. A cryptographic key for this TLS communication may be held in communicator 216.

### 1.5 Configuration of Digital Watermark Server 300

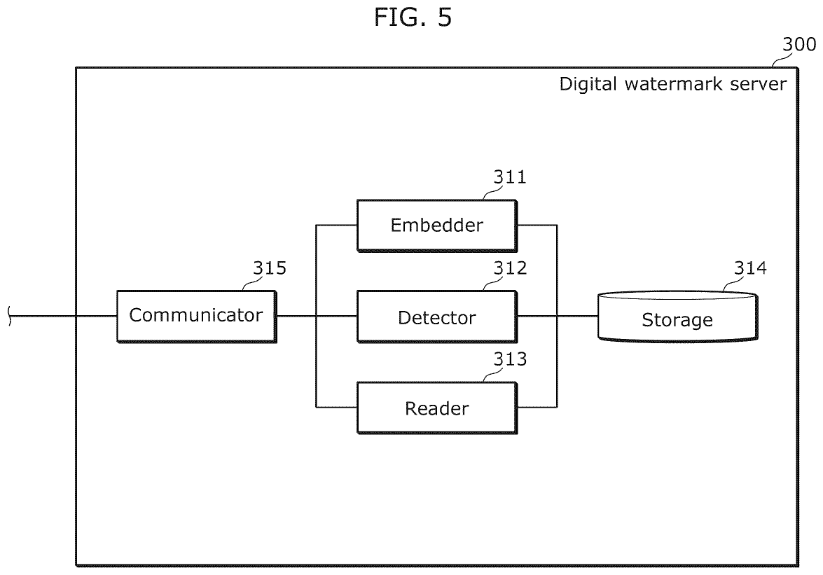

FIG. 5 is a configuration diagram of digital watermark server 300.

As illustrated in FIG. 5, digital watermark server 300 includes embedder 311, detector 312, reader 313, storage 314, and communicator 315. Digital watermark server 300 is a server that is a computer connected to communication network 500, but may be an information processing device such as a smartphone or a personal computer. Embedder 311, detector 312, and reader 313 included in digital watermark server 300 may be implemented by a processor (for example, a CPU) included in digital watermark server 300 executing a predetermined program using memory.

Embedder 311 embeds a digital watermark in image data. Specifically, when embedder 311 receives a watermark embedding request from terminal 110, embedder 311 embeds, as a digital watermark, information included in the watermark embedding request, in the image data included in the watermark embedding request. Embedder 311 transmits the image data with the digital watermark embedded therein via communicator 315 to terminal 110 that has transmitted the watermark embedding request. Embedder 311 may store, into storage 314, the image data included in the watermark embedding request or the image data with the digital watermark embedded therein.

When detector 312 receives a watermark reading request from terminal 100 or service server 400, detector 312 determines whether a digital watermark has been embedded in image data included in the watermark reading request. When it is determined that a digital watermark has been embedded in the image data, and the image data is provided to reader 313, reader 313 reads information from the digital watermark. Detector 312 may report the result of this determination to terminal 100 or service server 400 from which the watermark reading request has been transmitted. Detector 312 may store the received image data into storage 314.

When reader 313 obtains the image data with the digital watermark embedded therein (also referred to as watermarked image data) from detector 312, reader 313 reads information embedded as the digital watermark. Reader 313 transmits the read information via communicator 315 to terminal 100 or service server 400 from which the watermark reading request has been transmitted. Reader 313 may store the read information into storage 314.

Storage 314 is a storage device in which the information received from terminal 110, etc., the image data generated by embedder 311, and the information read by reader 313 from the digital watermark are stored.

Communicator 315 communicates with terminal 100 or 110 or service server 400. The communication may be performed using TLS. A cryptographic key for this TLS communication may be held in communicator 315.

### 1.6 Configuration of Service Server 400

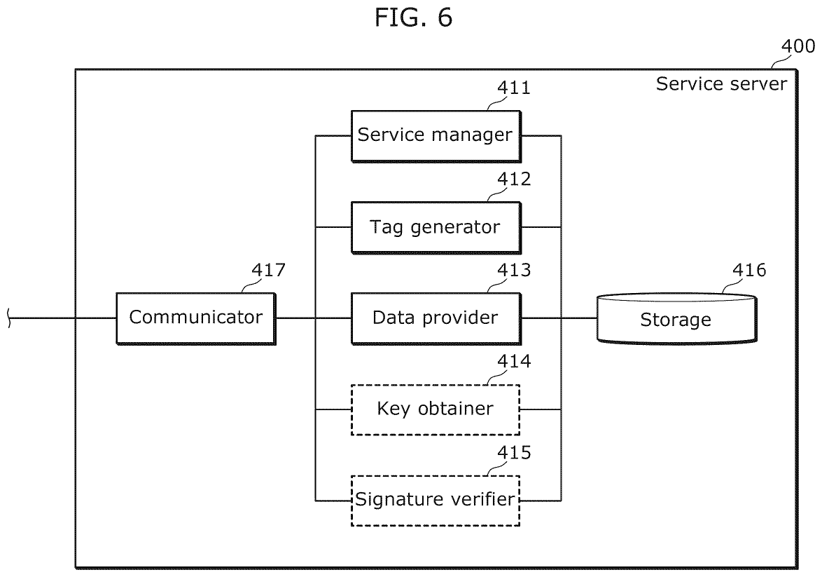

FIG. 6 is a configuration diagram of service server 400.

As illustrated in FIG. 6, service server 400 includes service manager 411, tag generator 412, data provider 413, key obtainer 414, signature verifier 415, storage 416, and communicator 417. Key obtainer 414 and signature verifier 415 are not essential and, in some cases, are not necessary depending on the processing performed by service server 400. Service server 400 is a server that is a computer connected to communication network 500, but may be an information processing device such as a smartphone or a personal computer. Service manager 411, tag generator 412, data provider 413, key obtainer 414, and signature verifier 415 included in service server 400 may be implemented by a processor (for example, a CPU) included in service server 400 executing a predetermined program using memory.

Service manager 411 manages an NFT and a service related to the NFT. Service manager 411 provides a virtual space in which image data that is an NFT owned by a user is exhibited (for example, what is called a metaverse space), and manages a user who logs in said virtual space, as the service related to the NFT, for example. The image data exhibited may include both image data that is an NFT and image data that is not an NFT. Note that service manager 411 may provide, as a place where image data that is an NFT owned by a user is to be exhibited, a website with which terminal 100 can communicate (for example, a website accessible according to a communication protocol such as the hypertext transfer protocol (HTTP) or the file transfer protocol (FTP)).

Tag generator 412 generates an NFT tag which is information associated with image data that is an NFT. The NFT tag is information indicating that the image data associated with said NFT tag is an NFT. The NFT tag includes a random number and the identifier of the NFT. Furthermore, a signature using a private key to the NFT owner account for said random number and said identifier is added to the NFT tag. When terminal 100 reads the image data exhibited by service server 400, terminal 100 recognizes the NFT tag associated with said image data.

Data provider 413 provides an NFT and information related to the NFT that are managed by service manager 411. The NFT that is provided by data provider 413 may be the NFT held by terminal 110, for example. The information related to the NFT that is provided by data provider 413 may be information related to NFT trading. The information related to NFT trading is, for example, information indicating that the NFT is tradable. The information related to the NFT may include the NFT tag.

Key obtainer 414 obtains the public key to the NFT owner account that has been registered on the blockchain. The owner account can be specified by referring to the blockchain on the basis of the NFT-ID read from the digital watermark embedded in the image data. Furthermore, the owner account can be specified by self-reporting by terminal 110. Key obtainer 414 is not essential.

Using the public key obtained by key obtainer 414, signature verifier 415 verifies the signature added to the NFT tag generated by tag generator 412. Signature verifier 415 is not essential.

In storage 416, user information required to provide a service, the image data of an NFT image, the public key obtained by key obtainer 414, and the like are stored.

Communicator 417 communicates with terminal 100 or 110, digital watermark server 300, or ledger server 200a, etc. The communication may be performed using TLS. A cryptographic key for this TLS communication may be held in communicator 417.

### 1.7 Overall Sequence

The overall sequence of verification system 10 will be described below.

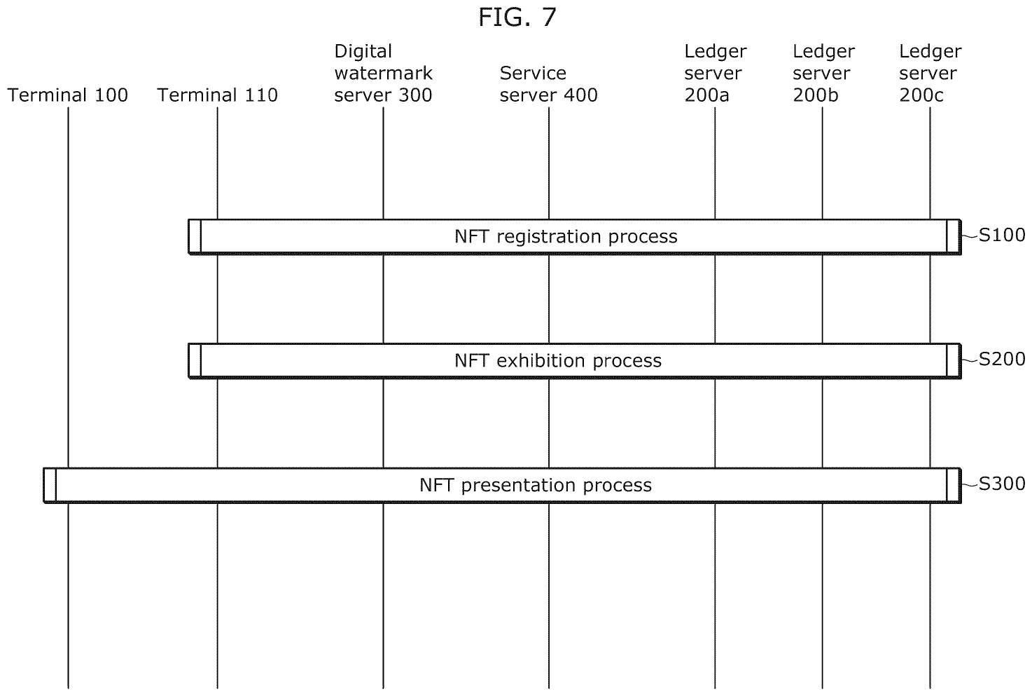

FIG. 7 is a sequence chart illustrating processes performed in verification system 10. Note that each of the processes indicated in FIG. 7 will be described in detail later.

In Step S100, terminal 110 and ledger server 200a, etc., perform the process of registering an NFT (also referred to as a registration process). Furthermore, terminal 110 and digital watermark server 300 embed a digital watermark in image data to be registered as an NFT.

In Step S200, terminal 110 and service server 400 perform the process of exhibiting the NFT (also referred to as an exhibition process) in the service provided by service server 400. Furthermore, service server 400 and digital watermark server 300 may perform the process of reading the digital watermark in the image registered as an NFT.

In Step S300, terminal 100, digital watermark server 300, service server 400, and ledger server 200a, etc., perform the process of presenting (specifically, displaying) image data that is an NFT on terminal 100 (also referred to as a presentation process). Furthermore, the process of verifying the image data that is an NFT is performed when terminal 100 displays the NFT.

### 1.7.1 Sequence of NFT Registration Process

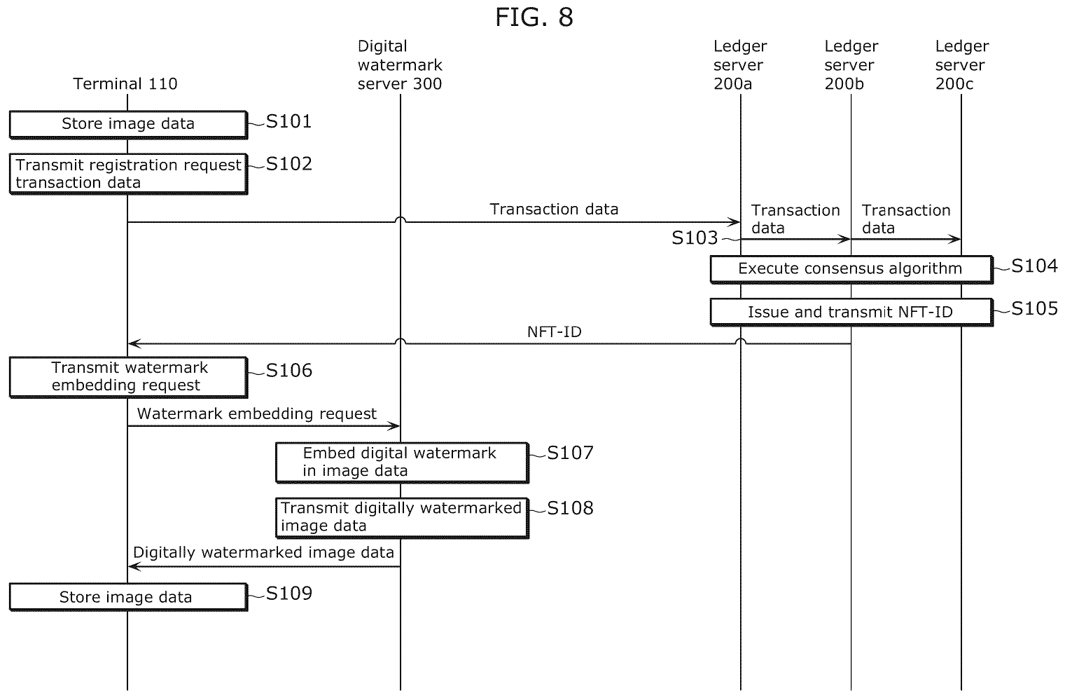

The sequence of the NFT registration process will be described below. FIG. 8 is a sequence chart illustrating the first example of the NFT registration process (Step S100 in FIG. 7) according to the present embodiment.

At the point in time when Step S101 indicated in FIG. 8 is performed, terminal 110 holds the image data to be registered as an NFT.

In Step S101, terminal 110 stores the image data to be registered as an NFT. The storage location for the image data may be a storage device included in terminal 110 or may be a storage device included in a device different from terminal 110.

In Step S102, using information such as the storage location where the image data has been stored in Step S101, terminal 110 registers the image data with ledger server 200a, etc., as an NFT. Specifically, terminal 110 generates registration request transaction data and transmits the registration request transaction data to ledger server 200a. The registration request transaction data is transaction data including: information indicating the storage location for the NFT (for example, a uniform resource locator (URL)); and the blockchain address of terminal 110 as an account that registers the NFT (also referred to as a registration account). Ledger server 200a receives the registration request transaction data transmitted thereto. Note that the description herein uses ledger server 200a as a representative of ledger server 200a, etc., but ledger server 200b or 200c can also be used in the description instead of ledger server 200a. The same applies to the following cases.

In Step S103, ledger server 200a verifies the authenticity of the registration request transaction data received from terminal 110. When this verification is successful, ledger server 200a transfers the registration request transaction data to other ledger servers 200b, 200c. Other ledger servers 200b, 200c receive the registration request transaction data transferred thereto, and verify the authenticity of the registration request transaction data as with ledger server 200a. Note that the process in which ledger server 200a, etc., transfers, for verification, the transaction data received from terminal 110 is also performed on other transaction data and therefore, description thereof may be omitted below.

In Step S104, ledger server 200a, etc., executes a consensus algorithm to verify the authenticity of the received registration request transaction data. Furthermore, ledger server 200a, etc., generates a block including the registration request transaction data, and stores the block into the blockchain.

In Step S105, ledger server 200a executes a smart contract on the basis of the fact that the registration request transaction data has been stored into the blockchain in Step S104, thereby issuing NFT-ID. The issued NFT-ID is stored into the blockchain. For example, terminal 110 may generate transaction data including the NFT-ID and store the transaction data into the blockchain. Ledger server 200a transmits the issued NFT-ID to terminal 110. Terminal 110 receives the NFT-ID transmitted thereto. The NFT-ID is a distinguishing identifier (for example, number) unique to the NFT. After the issuance of the NFT-ID, in response to an inquiry about the NFT registration account that is made using the issued NFT-ID, ledger server 200a can transmit the NFT registration account by referring to the blockchain. Furthermore, in response to an inquiry about the NFT owner account that is made using the issued NFT-ID, ledger server 200a can refer to the blockchain and transmit the NFT owner account valid at that point in time. The NFT owner account is the transfer destination account included in the latest transfer transaction data.

In Step S106, terminal 110 transmits, to digital watermark server 300, a request for embedding a digital watermark in the image data stored in Step S101 (in other words, the image data registered as an NFT in Steps S102 to S105) (also referred to a watermark embedding request). Digital watermark server 300 receives the watermark embedding request.

The watermark embedding request includes: the image data stored in Step S101; the NFT-ID received in Step S105; the blockchain address of terminal 110 as the NFT registration account; and the signature generated using the private key to said registration account. Note that the watermark embedding request may further include: information indicating the platform of the blockchain; and the address of the smart contract used for NFT registration. Information for use in signature generation is the NFT-ID and the blockchain address of terminal 110 as the NFT registration account. The information for use in signature generation may further include: information of the platform of the blockchain; and the address of the smart contract used for NFT registration. The information for use in signature generation may further include a random number.

In Step S107, digital watermark server 300 embeds information other than the image data included in the watermark embedding request received in Step S106 into the image data as a digital watermark. At this time, digital watermark server 300 may verify the signature included in the received watermark embedding request.

The public key to the registration account, which is required to verify the signature included in the watermark embedding request, can be obtained, for example, using the NFT registration account (that is, the blockchain address of terminal 110) included in the received watermark embedding request. The public key to the registration account can be obtained by referring to the blockchain using the NFT-ID.

Digital watermark server 300 may be configured to, when the verification of a signature is conducted, embed a digital watermark in image data when the verification is successful, and not embed the digital watermark in the image data when the verification is unsuccessful. Furthermore, when the verification is unsuccessful, digital watermark server 300 may report the result of this verification to terminal 110. The format of information to be embedded is arbitrary; for example, the information may be embedded as text, or encoded information (such as a bit string, a two-dimensional code represented by a QR code (registered trademark), or a barcode) may be embedded, meaning that the information may be in any format as long as the information can be properly read from said digital watermark.

In Step S108, digital watermark server 300 transmits the image data with the digital watermark embedded therein in Step S107 (also referred to as digitally watermarked image data) to terminal 110. Terminal 110 receives the digitally watermarked image data transmitted thereto.

In Step S109, terminal 110 stores, as data linked to the NFT, the digitally watermarked image data received in Step S108. Terminal 110 overwrites and saves the received digitally watermarked image data at the storage location where the image data has been stored in Step S101.

Note that in the NFT registration process, the image data may be registered as an NFT after the process of embedding a digital watermark in the image data is performed. The flow of processes in this case will be described below.

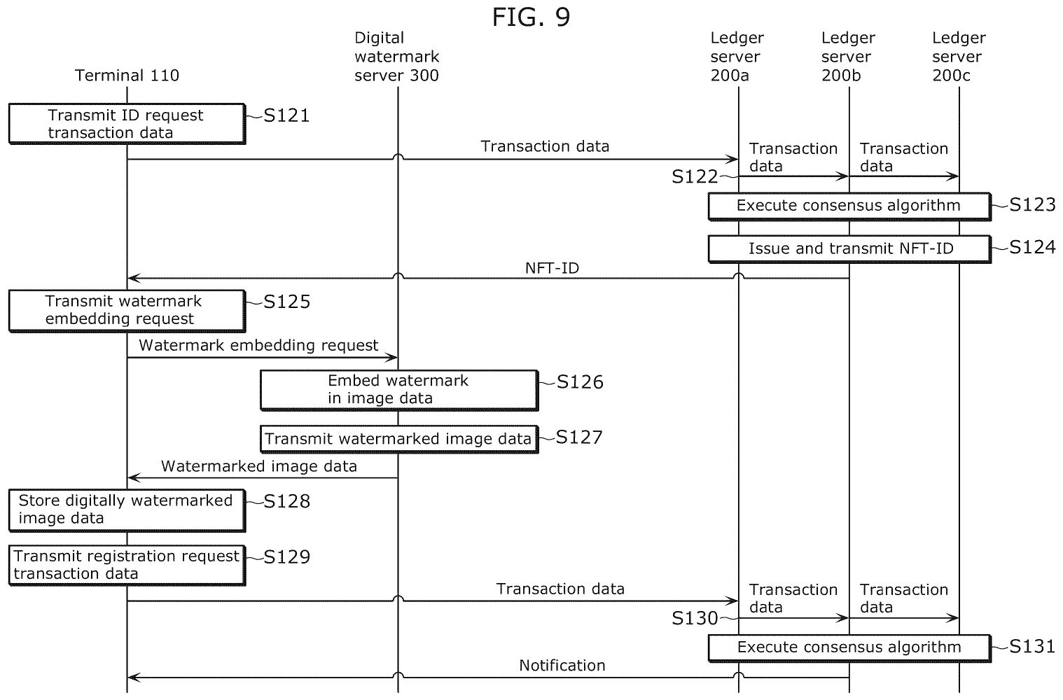

FIG. 9 is a sequence chart illustrating the second example of the NFT registration process according to the present embodiment.

In Step S121, terminal 110 transmits, to ledger server 200a, transaction data for requesting issuance of NFT-ID (also referred to as ID request transaction data). The ID request transaction data includes request information for requesting issuance of new NFT-ID. Ledger server 200a receives the ID request transaction data transmitted thereto.

In Step S122, ledger server 200a verifies the authenticity of the ID request transaction data received from terminal 110 and furthermore, other ledger servers 200b, 200c also verify the authenticity of the ID request transaction data (as in Step S103).

In Step S123, ledger server 200a, etc., executes a consensus algorithm to verify the authenticity of the received ID request transaction data. Furthermore, ledger server 200a, etc., generates a block including the ID request transaction data, and stores the block into the blockchain.

In Step S124, ledger server 200a executes a smart contract on the basis of the fact that the ID request transaction data has been stored into the blockchain in Step S123, thereby issuing NFT-ID. Ledger server 200a transmits the issued NFT-ID to terminal 110. Terminal 110 receives the NFT-ID transmitted thereto.

In Steps S125 to S128, terminal 110 and digital watermark server 300 perform the processes of embedding a digital watermark in the image (in other words, processes that are substantially the same as those in Steps S106 to S109 in FIG. 8).

In Step S129, terminal 110 transmits registration request transaction data. The registration request transaction data is the same as the registration request transaction data indicated in FIG. 8. Ledger server 200a receives the registration request transaction data transmitted thereto.

In Step S130, ledger server 200a verifies the authenticity of the registration request transaction data received from terminal 110 and furthermore, other ledger servers 200b, 200c also verify the authenticity of the registration request transaction data (as in Step S103).

In Step S131, ledger server 200a, etc., executes a consensus algorithm to verify the authenticity of the received registration request transaction data. Furthermore, ledger server 200a, etc., generates a block including the registration request transaction data, and stores the block into the blockchain. Subsequently, ledger server 200a reports the result of the verification of the authenticity of the registration request transaction data to terminal 110.

Through the series of processes indicated in FIG. 8 or FIG. 9, verification system 10 can properly register the image data held by terminal 110 on the blockchain as an NFT, thereby contributing to the circulation of the image data, which is one example of the content data, with the uniqueness thereof guaranteed.

### 1.7.2 Sequence of NFT Exhibition Process

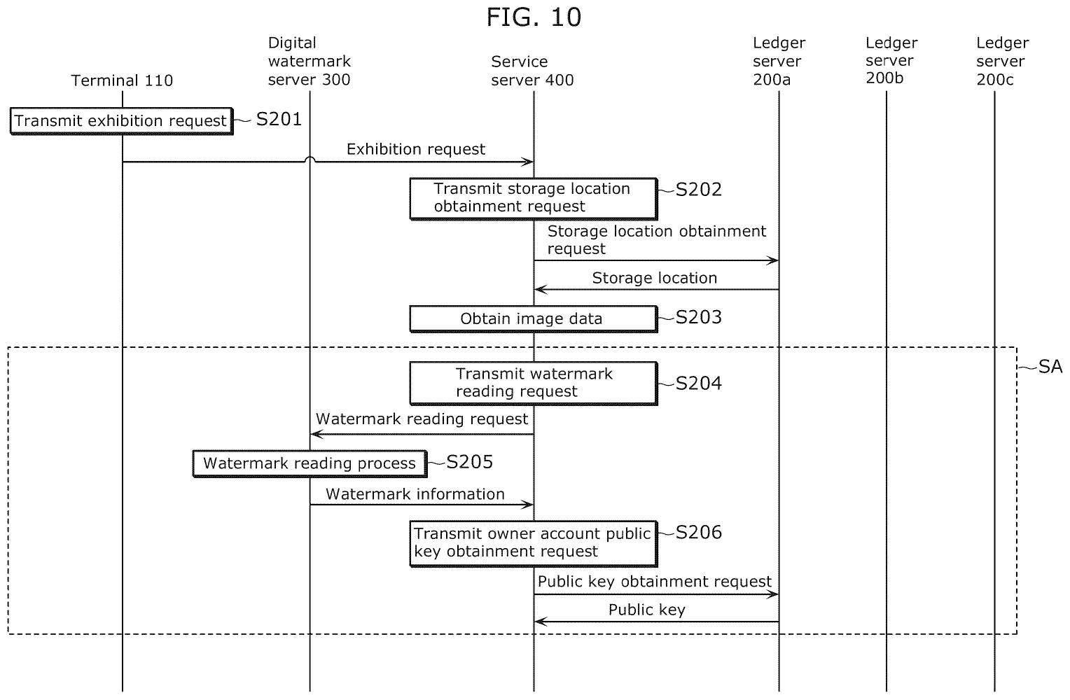

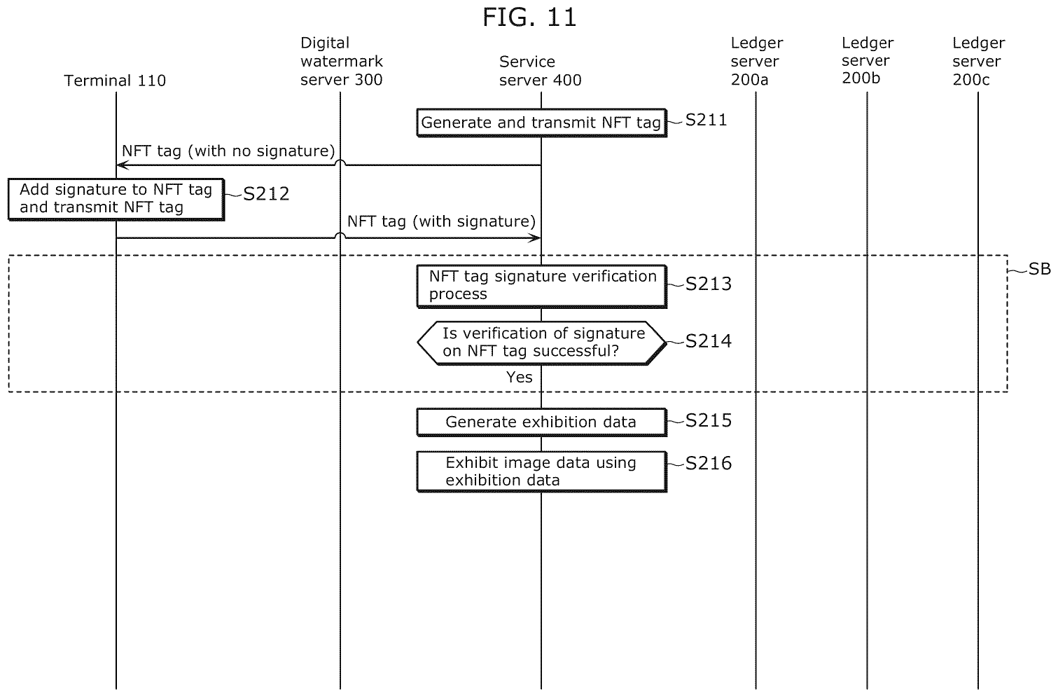

The sequence of the NFT exhibition process will be described below. FIG. 10 and FIG. 11 are sequence charts illustrating one example of the NFT exhibition process (Step S200 in FIG. 7) according to the present embodiment.

Note that the description herein includes processes in which service server 400 and digital watermark server 300 verify the owner account read from the digital watermark (that are the processes included in frame SA in FIG. 10 and frame SB in FIG. 11), but these processes are not essential.

In Step S201, terminal 110 transmits an exhibition request to service server 400. The exhibition request includes the NFT-ID of image data that is an NFT held by terminal 110 and is desired to be exhibited on service server 400. Service server 400 receives the exhibition request transmitted thereto.

Note that terminal 110 that performs Step S201 may be the same as or different from terminal 110 used in the NFT registration process (Step S100). Terminal 110 that performs Step S201 is different from terminal 110 used in the NFT registration process (Step S100) when the NFT has been transferred using the transfer transaction data, for example.

In Step S202, service server 400 transmits, to ledger server 200a, a request for obtaining the storage location for image data that is an NFT (also referred to as storage location obtainment request) that includes the NFT-ID included in the exhibition request received in Step S201. Ledger server 200a receives the storage location obtainment request and obtains, by referring to the blockchain, the storage location for the image data that is indicated by the NFT-ID included in the storage location obtainment request. Ledger server 200a transmits information indicating the obtained storage location to service server 400. Service server 400 receives the transmitted information indicating the storage location.

In Step S203, from the storage location indicated in the information received in Step S202, service server 400 obtains the image data that is to be exhibited.

After obtaining the NFT image data in Step S203, service server 400 may, but not necessarily, verify the owner account holding said image data. For example, service server 400 that conducts proper NFT exhibition is expected to verify the owner account. On the other hand, service server 400 that conducts improper NFT exhibition may skip verifying the owner account. Processes to be performed to verify the owner account are indicated within frame SA. Service server 400 that does not verify the owner account skips the processes indicated within frame SA.

In Step S204, service server 400 transmits, to digital watermark server 300, a request for reading the digital watermark from the image data (the watermark reading request), in order to verify the image data obtained in Step S203. The watermark reading request includes the image data obtained in Step S203. Digital watermark server 300 receives the watermark reading request.

In Step S205, digital watermark server 300 performs a watermark reading process following the reception of the watermark reading request in Step S204. The watermark reading process is the process of reading information embedded as a digital watermark in the image data included in the watermark reading request. Digital watermark server 300 transmits, to service server 400, the information read in the watermark reading process (also referred to as watermark information). Service server 400 receives the watermark information. The watermark information includes at least the NFT-ID, the NFT registration account, and the signature.

In Step S206, service server 400 transmits, to ledger server 200a, a request for obtaining the public key to the owner account holding the image data that is an NFT that includes the NFT-ID included in the watermark information received in Step S205 (also referred to as a public key obtainment request). Ledger server 200a receives the public key obtainment request, obtains, by referring to the blockchain, the owner account holding the image data that is indicated by the NFT-ID included in the public key obtainment request, and further obtains the public key to said owner account. Ledger server 200a transmits the obtained public key to service server 400. Service server 400 receives the public key transmitted thereto.

Referring to FIG. 11, in Step S211, service server 400 generates an NFT tag associated with the image data to be exhibited. The NFT tag includes the NFT-ID and the random number. At this point in time, no signature has been added to the NFT tag. Service server 400 transmits the generated NFT tag to terminal 110. Terminal 110 receives the NFT tag transmitted thereto.

In Step S212, terminal 110 adds, to the NFT tag received in Step S211, a signature generated using the private key to the NFT owner account. Terminal 110 transmits, to service server 400, the NFT tag to which the signature has been added. Service server 400 receives the NFT tag transmitted thereto.

After receiving the NFT tag in Step S212, service server 400 may, but not necessarily, verify the signature on the NFT tag. Whether to verify the signature on the NFT tag depends on whether the processes in frame SA have been performed after Step S203. Processes to be performed to verify the signature on the NFT tag are indicated within frame SB. Service server 400 that does not verify the signature on the NFT tag skips the processes indicated within frame SB.

In Step S213, using the public key obtained in Step S206, service server 400 performs the process of verifying the signature on the NFT tag received in Step S212.

In Step S214, service server 400 determines whether the verification is successful in the signature verification process performed in Step S213. When it is determined that the verification is successful (Yes in Step S214), the processing proceeds to Step S215. Note that when it is determined that the verification is unsuccessful (that is, there is a verification failure) (not illustrated in the drawings), service server 400 stops the exhibition process at this point in time. In this case, service server 400 may notify terminal 110 that the verification of the signature on the NFT tag has been unsuccessful or the exhibition process has been stopped.

In Step S215, service server 400 generates exhibition data using the image data that is an NFT. The exhibition data is one electronic file including the image data and the NFT tag associated with said image data, for example. It is sufficient that the exhibition data be one unit of data including the image data and the NFT tag associated with said image data, meaning that the exhibition data is not limited to one electronic file.

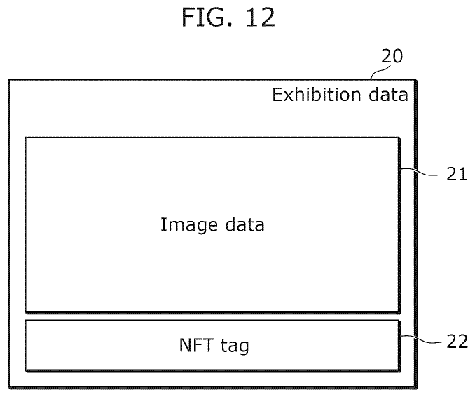

The structure of the exhibition data will be described with reference to FIG. 12. FIG. 12 is an explanatory diagram illustrating one example of the structure of the exhibition data. Exhibition data 20 illustrated in FIG. 12, which is one electronic file, includes: image data 21 that is an NFT; and NFT tag 22 associated with image data 21.

In Step S216, using the exhibition data generated in Step S215, service server 400 exhibits, on service server 400, the image data that is an NFT. Exhibiting the image data on service server 400 includes, for example, exhibiting the image data in a virtual space provided by service server 400 so that users can browse the image data and exhibiting the image data on a website provided by service server 400 so that users can browse the image data. At this time, on the exhibition by service server 400, image data that is an NFT and ordinary image data (in other words, image data that is not an NFT) are exhibited in different forms. Image data that is an NFT and ordinary image data may be distinguished from each other depending on whether there is an NFT tag.

Through the series of processes indicated in FIG. 10 or FIG. 11, verification system 10 can more properly exhibit, by service server 400, the image data that is an NFT, thereby contributing to the circulation of the image data, which is one example of the content data, with the uniqueness thereof guaranteed.

### 1.7.3 Sequence of NFT Presentation Process

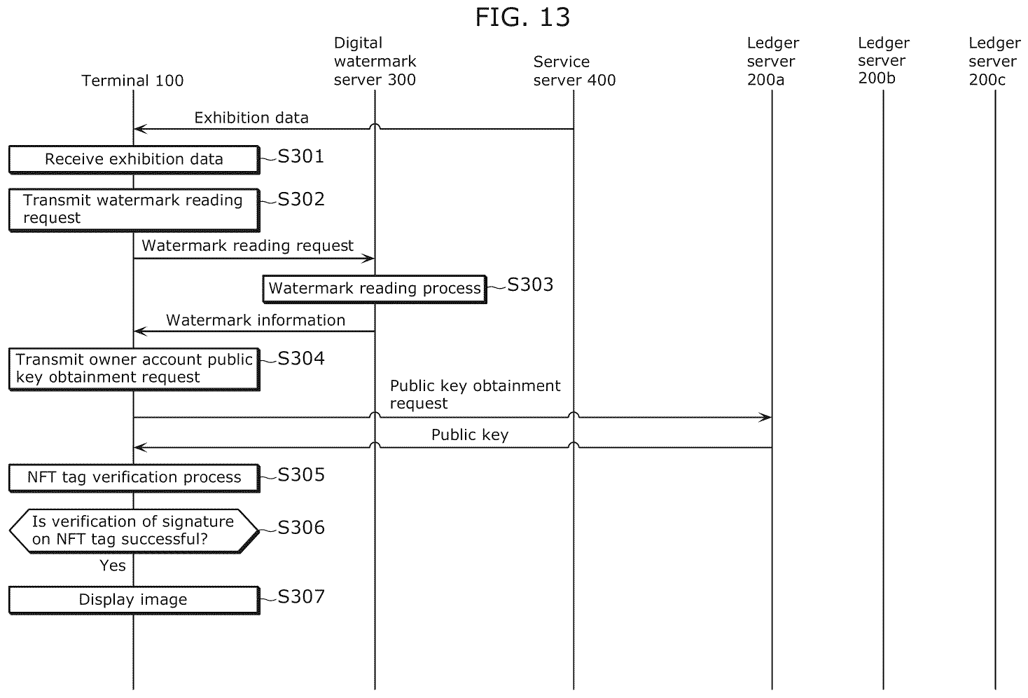

The sequence of the NFT presentation process will be described below. FIG. 13 is a sequence chart illustrating one example of the NFT presentation process (Step S300 in FIG. 7) according to the present embodiment.

In Step S301, terminal 100 receives: the exhibition image data exhibited on service server 400, in other words, the image data that is an NFT; and the NFT tag associated with said image data. In the image data that is an NFT, NFT-ID which is the identifier of said image is embedded as a digital watermark. Furthermore, the NFT tag may include the NFT-ID and the digital signature of the owner account holding the image data. In this situation, terminal 100 receives one electronic file including: the image data that is an NFT; and the NFT tag associated with said image data. Note that when the image data that is an NFT and the NFT tag do not constitute one electronic file, each of the image data that is an NFT and the NFT tag is received.

In Step S302, when terminal 100 recognizes that the exhibition data received in Step S301 includes the NFT tag, terminal 100 transmits, to digital watermark server 300, the watermark reading request including the image data included in the exhibition data received in Step S301. Digital watermark server 300 receives the watermark reading request.

In Step S303, digital watermark server 300 performs the watermark reading process following the reception of the watermark reading request in Step S302. Digital watermark server 300 transmits, to terminal 100, watermark information read in the watermark reading process. Terminal 100 receives the watermark information transmitted thereto.

In Step S304, using the NFT-ID included in the watermark information received from digital watermark server 300 in Step S303, terminal 100 specifies, from the blockchain, an owner account holding the corresponding NFT, and obtains the public key to the owner account. At the time of specifying the NFT owner account using the NFT-ID, transaction data stored in the blockchain and indicating the transfer of the NFT can be referred to, making it possible to determine that the latest transfer destination account for the NFT is the owner account holding the NFT at the present.

Note that using the NFT-ID stated on the NFT tag included in the exhibition data received in Step S301, terminal 100 can specify, from the blockchain, the owner account holding the corresponding NFT, and obtain the public key to said owner account.

Note that using the NFT-ID, terminal 100 can trace back the trades of the corresponding NFT, thereby specify the registration account for the NFT, and obtain the public key to the registration account. Furthermore, using the NFT-ID read from the digital watermark, terminal 100 can obtain the public key to the registration account in substantially the same method as that described above.

In Step S305, terminal 100 performs an NFT tag verification process. The NFT tag verification process includes the process of verifying the signature included in the NFT tag. First, terminal 100 determines whether there is a match between the NFT-ID included in the NFT tag and the NFT-ID embedded in the image data as a digital watermark. When terminal 100 determines that there is no match between these NFT-IDs, terminal 100 causes the NFT-ID verification to be unsuccessful. In other words, a match between these NFT-IDS is one condition for successful NFT-ID verification.

Furthermore, using the public key to the registration account, terminal 100 may verify the signature embedded in the image data as a digital watermark. A success of this verification may be one condition for successful NFT-ID verification.

Furthermore, using the public key to the owner account, terminal 100 may verify the signature included in the NFT tag. A success of this verification may be one condition for successful NFT-ID verification.

Furthermore, terminal 100 may determine whether there is a match between the registration account included in the watermark information received from digital watermark server 300 in Step S303 and the NFT registration account stored in the blockchain of ledger server 200a (that is, the registration account that has registered the image data as an NFT). When there is no match between these registration accounts, terminal 100 may cause the NFT verification to be unsuccessful. In other words, a match between these registration accounts may be one condition for successful NFT-ID verification.

In Step S306, when even one verification in the verification process in Step S305 is unsuccessful (not illustrated in the drawings), terminal 100 stops the presentation process, in other words, avoids displaying the image data (in other words, prohibits the presentation). At this time, terminal 100 may handle the NFT as being fraudulent. Specifically, terminal 100 may discard the image data included in the exhibition data received in Step S301, may handle said image data as ordinary image data that is not an NFT, may perform image processing on said image data to reduce the chroma, the level of transparency, or the luminance of an image based on said image data and display a resultant image, or may display nothing in a space in which said image is to be displayed. Furthermore, terminal 100 may report to service server 400 that said image data is a fraudulent NFT. Service server 400 that has received the report may take appropriate measures such as suspending the account that has created the fraudulent NFT.

When there is no unsuccessful verification in the verification process in Step S305, that is, when the verification is successful (Yes in Step S306), the processing proceeds to Step S307.

In Step S307, terminal 100 displays an image based on the image data that is an NFT. It can be said that the image data for display is guaranteed by the NFT tag as authentic image data that has not been tampered with, for example.

The series of processes indicated in FIG. 13 allows for contribution to the circulation of the image data, which is one example of the content data, with the uniqueness thereof guaranteed.

### Additional Comments

The following are additional comments on the distributed ledger according to the above embodiment. A blockchain will be described herein as an example of the distributed ledger, but the same is true for other distributed ledgers.

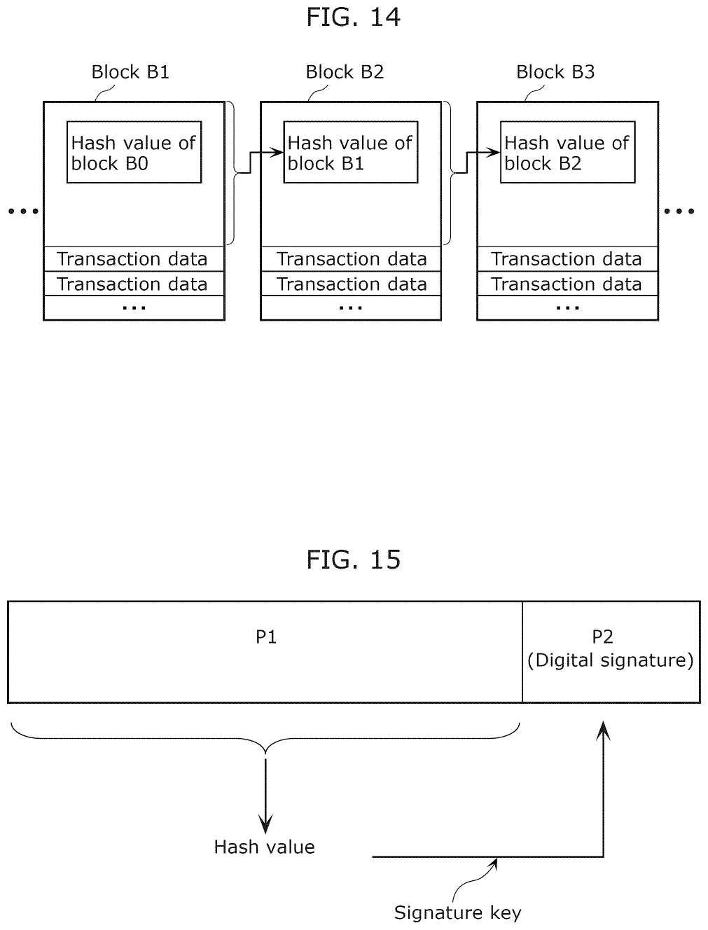

FIG. 14 is an explanatory diagram illustrating the data structure of a blockchain.

A blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

FIG. 15 is an explanatory diagram illustrating the data structure of transaction data.

The transaction data illustrated in FIG. 15 includes transaction body P1 and digital signature P2. Transaction body P1 is a data body included in said transaction data. Digital signature P2 is generated using a signature key of a creator of said transaction data for the hash value of transaction body P1; more specifically, digital signature P2 is generated by encrypting said hash value with a private key of the creator of said transaction data. As means for implementing the digital signature, the elliptic curve digital signature algorithm (ECDSA), CRYSTALS-DILITHIUM, FALCON, SPHINCS+, or the like may be used.

Because of including digital signature P2, the transaction data is virtually impossible to tamper with. This is because if the transaction data is tampered with, verification using digital signature P2 will be unsuccessful, which reveals that the transaction data has been tampered with. Thus, transaction body P1 is protected from tampering.

### 1.8 Advantageous Effects of Embodiment

In the present embodiment, even when service server 400 does not verity the authenticity of an NFT, terminal 100 can verify the authenticity by a device of its own. The authenticity of the NFT herein means that image data has not been tampered with from when the image data was registered as an NFT to when terminal 100 obtained the image data, that image data is not a counterfeit NFT created by copying original NFT image data, or that an NFT is exhibited by an owner account, for example. Tampering with image data can be detected through verification of a signature embedded as a digital watermark. Whether an NFT is a counterfeit can be detected using NFT-ID on an NFT tag and NFT-ID embedded as a digital watermark. Whether an NFT is exhibited by an owner account can be detected through verification of a signature included in an NFT tag. Even when service server 400 has not verified the authenticity of the NFT, said detection can be carried out as long as terminal 100 and digital watermark server 300 and communication with ledger server 200a are available.

### 2. Other Variations

The present disclosure has been described thus far based on the above embodiment, but it goes without saying that the present disclosure is not limited to the above embodiment. The following examples are also intended to be included within the scope of the present disclosure.

(1) In the above embodiment, terminal 100 or 110 and digital watermark server 300 are described as separate devices, but terminal 100 or 110 and digital watermark server 300 may be the same device.

(2) In the above embodiment, digital watermark server 300 and service server 400 are described as separate devices, but digital watermark server 300 and service server 400 may be the same device.

(3) In the above embodiment, digital watermark server 300 includes reader 313 and embedder 311 for digital watermarks, but these may be separate devices. In this case, embedder 311 for digital watermarks and terminal 100 or 110 may be the same device, and reader 313 for digital watermarks and terminal 100 or 110 may be the same device. Reader 313 for digital watermarks and service server 400 may be the same device.

(4) The blockchain stored in ledger server 200a, etc., in the above embodiment may be disclosed to service server 400 or terminal 100 or 110. Digital watermark server 300, service server 400, or terminal 100 or 110 may store the blockchain.

(5) In the above embodiment, the smart contract for registering an NFT is executed first and then the transaction data is generated (for example, refer to FIG. 8), but the digital watermark may be embedded in the image data first when the NFT-ID is known before the issuance of transaction (for example, refer to FIG. 9).

(6) In the above embodiment, service server 400 obtains the public key to the owner account before generating the NFT tag, but may obtain the owner account immediately before verifying the signature.

(7) In the above embodiment, the data to be registered as an NFT is image data, but the data to be registered as an NFT may be in any data format as long as a digital watermark can be embedded in the data. Examples of the data may include sound data, video data, or three-dimensional data in which a digital watermark can be embedded. Various data may be restated as metadata.

(8) In the above embodiment, the information to be embedded in the image data as a digital watermark is the information of the platform of the blockchain, the address of the smart contract used for NFT registration, the NFT-ID, the blockchain address of the NFT registrant terminal, and the signature using the private key to said address, but the address may be absent or the signature may be absent, for example. As long as the NFT is uniquely determined on the blockchain according to the information embedded in the digital watermark, the verification of the authenticity by users is realized.

(9) In the above embodiment, terminal 110 embeds the digital watermark by communicating with digital watermark server 300, service server 400 generates the NFT tag, and terminal 100 verifies the authenticity of the NFT, for example; however, these functions may be implemented using services or applications. There may be a service or an application including the function of embedding a digital watermark and registering an NFT, a service or an application that generates an NFT tag and adds a signature thereto, or a service an application that reads and verifies image data and an NFT tag with a signature, for example. These may be implemented as separate services or applications or may be implemented as one integrated service or application.

Furthermore, in the case where terminal 110 embeds a digital watermark in image data, an application that is installed on terminal 110 needs to include the function of embedding a digital watermark in image data. In the case where terminal 110 generates an NFT tag, an application that is installed on terminal 110 needs to include the function of generating an NFT tag.

In the case where terminal 100 verifies the authenticity of image data that is an NFT from an NFT tag and a digital watermark embedded in the image data, an application that is installed on terminal 100 needs to include the function of verifying the authenticity of image data.

(10) The above embodiment and the above variations may be combined.

Note that in the above embodiment, each of the structural elements may be configured in the form of an exclusive hardware product, or may be realized by executing a software program suitable for the structural element. Each of the structural elements may be implemented by a program execution unit such as a CPU or a processor reading and executing the software program recorded on a recording medium such as a hard disk or semiconductor memory. Here, the software program for implementing the information processing device, etc., according to the above embodiment is a program described below.

Specifically, this program causes a computer to perform an information processing method including: obtaining (a) content data which represents content and in which a digital watermark is embedded and (b) tag information associated with the content data; verifying whether there is a match between information of an owner of the content that is specified based on the digital watermark and information of the owner of the content that is obtained from the tag information; and when the verifying is successful, presenting the content.

The information processing device, etc., according to one or more aspects have been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### Industrial Applicability

The present disclosure enables authenticity verification by only a user alone and a blockchain in the circulation of NFTs, allowing for secure data circulation regardless of a platform for exhibition.

1. An information processing method comprising:
obtaining (a) content data which represents content and in which a digital watermark is embedded and (b) tag information associated with the content data;
verifying whether there is a match between information of an owner of the content that is specified based on the digital watermark and information of the owner of the content that is obtained from the tag information; and
when the verifying is successful, presenting the content.

2. The information processing method according to claim 1, wherein
the digital watermark includes content identification (ID) that is an identifier of the content,
the tag information includes a digital signature of the owner of the content, and
when there is a match between information of the owner of the content that is specified using the content ID read from the digital watermark and information of the owner of the content that is obtained from the digital signature, the content is presented.

3. The information processing method according to claim 2, further comprising:
obtaining a public key of the owner of the content that is specified using the content ID read from the digital watermark;
verifying, using the public key obtained, the digital signature included in the tag information; and
when the verifying of the digital signature is successful, presenting the content.

4. The information processing method according to claim 3, wherein
when the verifying of the digital signature is unsuccessful, the presenting of the content is prohibited.

5. The information processing method according to claim 3, wherein
the verifying further includes:
when it is determined that there is no match between the content ID read from the digital watermark and the content ID included in the tag information, causing the verifying to be unsuccessful.

6. The information processing method according to claim 3, wherein
the content has been registered as registered content by a plurality of servers included in a distributed ledger network,
in a distributed ledger held by the plurality of servers, registrant information indicating a registrant who has registered the content as the registered content is stored,
the digital watermark further includes registrant information indicating the registrant who has registered the content, and
the verifying further includes:
when it is determined that there is no match between the registrant information indicating the registrant and having been read from the digital watermark and the registrant information stored in the distributed ledger, causing the verifying to be unsuccessful.

7. The information processing method according to claim 3, wherein
the content has been registered as registered content by a plurality of servers included in a distributed ledger network,
in a distributed ledger held by the plurality of servers, the content ID, a record of transfer of the content, and a public key to an owner account holding the content are stored in association each other, and
the obtaining of the public key includes:
obtaining the public key to the owner account holding the content that is associated with the content ID.

8. The information processing method according to claim 3, wherein
in the obtaining of the content data and the tag information,
one electronic file including the content data and the tag information is obtained.

9. The information processing method according to claim 3, wherein
the content data is a non-fungible token (NFT).

10. An information processing device comprising:
a data obtainer that obtains (a) content data which represents content and in which a digital watermark is embedded and (b) tag information associated with the content data;
a verifier that verifies whether there is a match between information of an owner of the content that is specified based on the digital watermark and information of the owner of the content that is obtained from the tag information; and
a presentation unit that when the verifying is successful, presents the content.

11. A non-transitory computer-readable recording medium having recorded thereon a program for causing a computer to perform the information processing method according to claim 1.
